(19) United States
(12) Patent Application Publication
(10) Pub. No.: US 2024/0338784 A1
(43) Pub. Date: Oct. 10, 2024

(54) SYSTEMS AND METHODS INTERFACING WITH SERVICE PROVIDERS

(71) Applicant: JPMORGAN CHASE BANK, N.A., New York, NY (US)

(72) Inventors: Jay GREENWALD, Livingston, NJ (US); Richard JESTER, Newark, DE (US); Bob HALPERN, Media, PA (US); Pavithra SWAMINATHAN, Lewis Center, OH (US)

(21) Appl. No.: 18/627,037

(22) Filed: Apr. 4, 2024

Related U.S. Application Data
(60) Provisional application No. 63/494,348, filed on Apr. 5, 2023.

(51) Int. Cl. G06Q 50/18

(52) U.S. Cl. CPC G06Q 50/18

(57) ABSTRACT

Systems and methods for interfacing with service providers are disclosed. A service provider interface computer program may onboard a service provider with an organization computer program for an organization; accessing one form of a plurality of forms, wherein the one form is automatically populated with service provider information for the service provider and submit a completed form to the organization computer program, the completed form comprising an inquiry. The organization computer program may route the completed form to an appropriate support team; receive, from the appropriate support team, a response to the completed form; route the response to the completed form to the service provider interface computer program; and track the response to the completed form using a resolution code.

### RELATED APPLICATIONS

This application claims priority to, and the benefit of, U.S. Provisional Patent Application Ser. No. 63/494,348, filed Apr. 5, 2023, the disclosure of which is hereby incorporated, by reference, in its entirety.

### BACKGROUND OF THE INVENTION

### 1. Field of the Invention

Embodiments are generally directed to systems and methods for interfacing with legal service providers, such as outside counsel, expert witnesses, etc., for an organization.

### 2. Description of the Related Art

Organizations often engage legal service providers to complete complex legal tasks requiring complex expertise. This engagement often results in administrative work for in-house counsel, in-house support groups, and other internal employees without the proper context, which may lead to delays and inefficiencies and potentially duplicative activities. For example, emails may be lost, misdirected, or ignored without any tracking to resolution. And for emails directed to group mailboxes, there may be a lack of individual ownership for incoming messages.

### SUMMARY OF THE INVENTION

Systems and methods for interfacing with service providers are disclosed. In one embodiment, a method may include: (1) onboarding, by a service provider interface computer program executed by an electronic device, a service provider with an organization computer program for an organization; (2) accessing, by the service provider interface computer program, one form of a plurality of forms, wherein the one form may be automatically populated with service provider information for the service provider; (3) submitting, by the service provider interface computer program, a completed form to the organization computer program, the completed form comprising an inquiry; (4) routing, by the organization computer program, the completed form to an appropriate support team; (5) receiving, by the organization computer program and from the appropriate support team, a response to the completed form; (6) routing, by the organization computer program, the response to the completed form to the service provider interface computer program; and (7) tracking, by the organization computer program, the response to the completed form using a resolution code.

In one embodiment, the method may also include linking the completed form to an inquiry.

In one embodiment, the completed form may be routed to the appropriate support team using routing rules.

In one embodiment, the routing rules may be dynamic.

In one embodiment, the appropriate support team may include a bot, and the bot generates the response to the completed form. The bot may be trained with historical inquiry and resolution data.

According to another embodiment, a method may include: (1) receiving, by an organization computer program for an organization executed by an organization computer processor and from a service provider interface computer program, a new inquiry option for an inquiry; (2) receiving, by the organization computer program, a selection of an inquiry type and a sub-inquiry type from the new inquiry option; (3) receiving, by the organization computer program, inquiry details for the inquiry; (4) providing, by the organization computer program, the inquiry type, the sub-inquiry type, and the inquiry details to a large language model; (5) receiving, by the organization computer program and from the large language model, an automated reply to the inquiry details; and (6) providing, by the organization computer program, the automated reply to the service provider interface computer program.

In one embodiment, the inquiry details may be provided in text form, in a verbal form, or in a document.

In one embodiment, the organization computer program further provides a prompt for the automated reply to the large language model.

In one embodiment, the large language model may be trained with historical data for the organization.

In one embodiment, the details may be received via a chatbot.

In one embodiment, the organization computer program generates a prompt for the automated reply for the large language model based on the inquiry type and sub-inquiry type.

In one embodiment, the method may also include evaluating, by the organization computer program, an accuracy of the automated reply.

According to another embodiment, a method may include: (1) training, by an organization computer program for an organization executed by an organization computer processor, a large language model with legal and financial data for the organization; (2) receiving, by the organization computer program, an inquiry for a timekeeper rate structure from a service provider interface computer program for a service provider; (3) providing, by the organization computer program, the inquiry to the large language model; (4) receiving, by the organization computer program and from the large language model, an initial timekeeper rate structure; (5) providing, by the organization computer program, the initial timekeeper rate structure to the service provider interface computer program; (6) receiving, by the organization computer program and from the service provider interface computer program, a response to the initial timekeeper rate structure; (7) providing, by the organization computer program, the response to the initial timekeeper rate structure to the large language model; (8) receiving, by the organization computer program and from the large language model, a revised timekeeper rate structure; and (9) providing, by the organization computer program, the revised timekeeper rate structure to the service provider interface computer program.

In one embodiment, the legal and financial data may include organization requirements, historical billing data, desired rate structures, budgets, market rates, and/or historical performance of the service provider.

In one embodiment, the large language model further provides negotiation strategies and potential counteroffers with the initial timekeeper rate structure.

In one embodiment, the inquiry may include a prompt for the initial timekeeper rate structure for the service provider.

In one embodiment, the method may also include re-training the large language model with an agreed-up timekeeper rate structure.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for interfacing with service providers according to an embodiment.

FIG. 2 shows a method for interfacing with service providers according to an embodiment.

FIG. 3 depicts an exemplary database hierarchy according to one embodiment.

FIG. 4 depicts a method for automated rate negotiation according to an embodiment.

FIG. 5 depicts a method for managing resolution tags according to an embodiment.

FIG. 6 depicts an exemplary computing system for implementing aspects of the present disclosure.

### DETAILED DESCRIPTION OF PREFERRED EMBODIMENTS

Systems and methods for interfacing with legal service providers are disclosed.

Embodiments may provide a legal service provider management system that directly connects legal service providers with administrative support teams in organizations, leveraging widget and API services across multiple user interface portals. Embodiments may include an authentication module and an inquiries module, a vendor profile module, a conflict waiver module, onboarding and offboarding modules, a rate negotiation module, a risk management/data sharing module, etc. Embodiments may provide an externally facing portal for legal service providers and internal portal for organization support teams. Embodiments may also include a central database of legal service provider information, a reporting module to monitor legal service provider activity and organization support team performance.

Embodiments may provide a portal, such as an outside counsel portal, that enables firms and other legal service providers to directly connect to in-house legal support teams to reduce administrative work for attorneys, enable efficiencies and improve controls via automation, and increase transparency/accountability relating to support processes. The portal may provide a user interface through which the legal service provider users can self-register for authenticating to the portal. For example, the authentication may be securely controlled by a dual authentication mechanism where the user's email address and domain are validated. After successful authentication, users can create inquiries and report required information to in-house legal support team.

Embodiments may provide accurate routing of messages to the appropriate stakeholder. For example, email domains often do not have logical or practical names and often contain abbreviations; this leads to increased processing time for an email to be delivered to the appropriate person. By routing messages to the appropriate person, such as a support team member, the processing time for incoming messages may be reduced.

The portal may provide different forms that may be available under different inquiry types and subtypes for the users to create their inquiries. Each form may contain different data elements, some of which may be required for completion before the legal service provider can submit the inquiry. For example, the forms may be designed using angular dynamic forms concept where in the dynamic form template is based on the metadata that describes a business object model. The structure of the data models may be database driven to facilitate quick updates and to maintain different form versions to handle changes in business requirements.

The use of different form versions allows for a support team member to view, for example, inquiry details for a previous inquiry without any risk of data loss or missing data. In addition, different versions of the same inquiry type form may be implemented for internal inquires as well as external inquiries.

The data model for the dynamic forms and rules for the inquiry workflow may be provided in an internal system and in a centralized repository for outside counsel and practice groups. The inquiry routing rules and Support team assignments for each type of inquiry may also be stored in a separate database. Legal service provider users may also attach documents in any suitable format (e.g., pdf format) to support the inquiry.

All the user interface data elements including attachments are transferred to the system through, for example, REST APIs. The REST APIs may be secured and accessible to only certain authorized user groups. The system may validate the submitted inquiry information and may create an inquiry. Based on the routing rules defined, for example, in a database, the inquiry may be assigned to a legal support team group. Legal service provider users can track the status of inquiries through dashboard in a user interface.

Embodiments provide secure communication of messages and/or data. For example, an email address of a submitter may be mapped to a recognized legal service provider entity that has a relationship with the organization. Entitlements may be granted at the vendor Level, thereby ensuring that new users will be associated with a verified legal service provider entity.

In embodiments, no documents or material legal information may be communicated by email. Instead, inquiries and relative enhancements require authentication.

Embodiments offer the support team a dashboard for the support team members to service the inquiries created. The support team members may be assigned appropriate roles via a centralized access and entitlements platform through which users may be assigned to one or multiple groups that are authorized to view the inquiries assigned to their team. They may also be assigned an individual role, or they may not be assigned a role. Support team members also can reassign the inquiries to a different team/individual. An API may be leveraged to determine the team members of each support group to facilitate reassignment. For example, support team members may be notified about assignments via persistent desktop alerts.

In embodiment, a broadcast notification system may be used to alert internal users of changes to relative inquiries that have been submitted or assigned to them in the portal.

An email notification system may be used to automatically trigger email alerts to the external legal service provider users for any updates to their inquiry.

Support group users may share an open or closed inquiry internally (e.g., within the organization). Support team members may share an inquiry with one or many of the employee using an employee lookup feature and may request advice/feedback on any of the inquiries that will trigger an automated email alert to employee. A “Share Inquiry” feature works with the organizations directory, and allows users who have not been granted support group level access to have view only access to single inquiry. Employees to whom the inquiry is shared are visible to support group users in the interface. Access to a shared inquiry can be revoked by removing through the interface by removing the employee's name from the Shared list.

Legal service provider users may also reopen any closed inquiry if they need further action on the closed inquiry. This feature may allow legal service provider users to appeal the decision by the support team or to seek further clarification. All relevant data from the original inquiry is copied to the new inquiry to reduce input requirements by the legal service provider user and to maintain the history of the inquiry for the next support team member assigned to the inquiry. Data from reopened inquiries allows the organization to create “First Call Resolution” metrics to determine the quality of support team responses.

The direct communication between legal service provider users and support teams saves a lot of administrative work in managing email communications and provides an effective and efficient way to track the inquiries and service the same. The use of required fields on inquiry forms significantly reduces back and forth communications regarding missing information typically found with email communications.

Embodiments may use a large language model (LLM) to automate timekeeper rate negotiations. Timekeeper rate negotiations generally involve the negotiation of billing rates between a financial institution and external legal service providers, such as law firms or individual attorneys. Traditionally, these negotiations require significant time and effort from both parties, often resulting in lengthy and complex discussions.

LLMs, such as OpenAI's GPT-3 may be used. The LLM may be trained on a legal and financial data, enabling it to understand and generate contextually relevant responses. In operation, the system receives input data related to the financial institution's requirements, historical billing data, and desired rate structures. The LLM then analyzes this information to generate negotiation strategies and potential counteroffers. Embodiments can also take into account various factors, such as the financial institution's budget constraints, market rates, and historical performance of the legal service providers.

Embodiments may provide a chatbot that may integrate with a LLM to automate responses and provide insightful comments for newly submitted inquiries in the field of legal operations. Legal operations encompass various tasks and processes within a legal department or organization, such as matter management, legal spend management, contract management, and compliance.

For example, when a new inquiry is submitted to the chatbot, a LLM may be used to analyze the content and context of the inquiry. The LLM may generate an autoreply that addresses the user's specific inquiry or concern and may add insightful comments to the autoreply. These comments may include additional context, suggestions, or references to relevant resources, thereby enriching the user's experience and providing further guidance.

Due to its integration with the LLM, the chatbot may continuously learn and improve its responses. It can adapt to changes in legal operations practices, stay up to date with emerging trends, and refine its knowledge base based on user interactions and feedback. In addition, the integration may enhance the accuracy and relevance of the responses, providing users with more valuable and tailored information. Moreover, the integration enables LOKI to leverage the latest advancements in natural language processing, ensuring a cutting-edge and efficient user experience.

Embodiments may also enable users to log inquiries on behalf of other employees within the organization. For example, as inquiries progress through the workflow, both the submitter and creator of the inquiry receive email alerts and updates. These alerts and updates may be sent as support group members work on resolving the inquiry until its completion. This ensures effective communication and collaboration among the involved parties, facilitating the timely resolution of inquiries and providing transparency throughout the process.

Embodiments may centralize key contacts for vendors, thereby providing a single source of truth for contact information. Both internal users and external third-party suppliers have the ability to view, edit, add, or deactivate contacts associated with a specific vendor. Thus, key contacts can be easily updated and maintained.

In addition, embodiments ensure that any updates made to key contacts are shared with other applications. This synchronization of data guarantees that changes made to key contacts are updated in real-time across all relevant systems downstream. This eliminates the need for redundant data entry and ensures consistency and accuracy of contact information throughout the organization.

Embodiments provide the ability to view, edit, add, and deactivate vendor profile locations (e.g., physical offices operated by vendors). Embodiments may distinguish between at least two types of locations, such as billing locations and office locations. Billing locations include payment information, while office locations do not.

Adding a new location may trigger a form that facilitates the collection of physical address information. This ensures accurate and up-to-date data for each vendor profile location.

Embodiments may manage resolution tags, which are metadata tags that provide administrators with valuable insights into the root cause and solution of each individual inquiry. Resolution tags may be organized by groups and stored in a single database table. This centralized storage allows for efficient management and retrieval of resolution tags.

Using resolution tags, administrators can easily categorize and analyze inquiries based on their root causes and corresponding solutions. This provides valuable insights for identifying patterns, improving processes, and enhancing overall efficiency in resolving inquiries.

Embodiments may ensure that resolution tags are readily accessible and can be easily associated with relevant inquiries, enabling administrators to make informed decisions and take appropriate actions based on the insights provided by the resolution tags.

In embodiments, once a certain number of inquiries have accumulated, embodiments may leverage a LLM to analyze and process various components such as summaries, comments, notes, and resolution tags that are indexed within the system. When a user attempts to complete an inquiry, embodiments may use the live data set to suggest additional metadata tags based on the information and tags added to previous inquiries. This intelligent suggestion mechanism enhances the accuracy and efficiency of tagging inquiries, providing users with relevant and valuable suggestions based on the historical data within the system.

By leveraging the power of the LLM and the accumulated data, the system streamlines the inquiry completion process, ensuring that inquiries are appropriately tagged with relevant metadata. This improves the overall organization and retrieval of inquiries, enabling users to quickly access and analyze relevant information for effective decision-making and problem-solving.

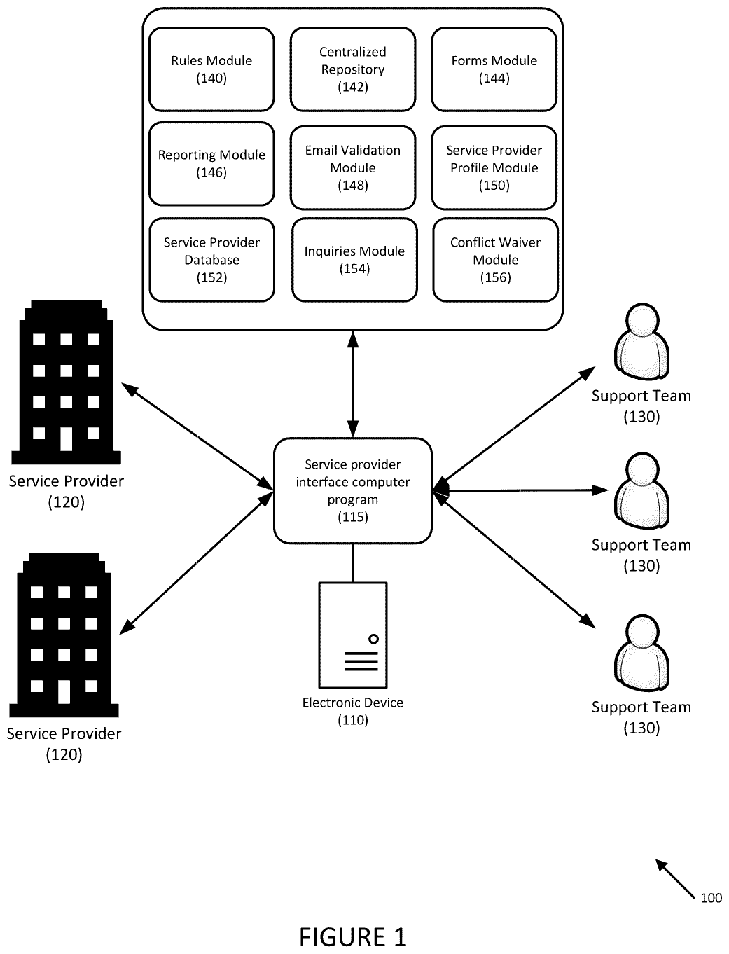

Referring to FIG. 1, a system for interfacing with service providers is disclosed according to an embodiment. System 100 may include electronic device 110, which may be a server (e.g., physical and/or cloud-based), computers (e.g., workstations, desktops, laptops, notebooks, tablets, etc.), etc. Electronic device 110 may execute service provider interface computer program 115, which may provide an interface, such as a portal, for service providers 120. Service providers 120 may access the portal using electronic devices (not shown).

Service provider interface computer program 115 may include or interface with a plurality of modules, including rules module 140, centralized repository 142, forms module 144, reporting module 146, email validation module 148, service provider profile module 150, service provider database 152, inquiries module 154, and conflicts waiver module 156. Additional and/or different modules may be used as is necessary and/or desired.

Rules module 140 may include routing rules that may identify one or more support team 130 to route an inquiry received from service provider 120.

Centralized repository 142 may store documents and information from service providers 120. Service provider interface computer program 115 may receive documents from centralized repository 142 and may make the documents and information available on the portal.

Forms module 144 may include forms used by service providers 120 to submit inquiries or communicate other information to the organization. The forms may be organized by topic and sub-topic. The forms may be updated periodically, and to allow the forms to be quickly updated to address any new trends, issues, etc.

In one embodiment, the forms may be customizable and reusable, and may be designed using a flexible extensible dynamic forms concept wherein the dynamic form template is based on the metadata that describes business object model. The structure of the data models is database driven to facilitate quick updates and maintain different form versions to handle changes in business requirements.

Reporting module 146 may track the activity of service providers and the support team's performance metrics. Reporting module 146 may generate reports to identify areas for improvement and helps users make data-driven decisions.

Email validation module 148 may verify the corporate email domain of the user by comparing it to a list of authorized domains maintained by the organization. If the email domain is not authorized, the user will be denied access to the email service. This reduces the risk of phishing and spoofing attacks and prevents unauthorized access to the email service.

Service provider profile module 150 may allow service providers 120 to maintain profile information, including key contacts, office locations, expertise, etc. Service providers 120 may maintain their own profiles and keep the information evergreen, reducing the time and effort required manage the service provider database. Service provider profile module may include, for example, a vendor profile that may include key information such as company name, address, phone number and website, key contacts that includes contact information of key personnel, including email addresses and phone numbers, office locations that include the address for each service provider office, and expertise that identifies the expertise provided by the service provider.

Service provider database 152 may be a central repository of service provider information that includes service provider contact details, expertise, hourly rates, working agreements, and risk metrics. The database may be accessed by authorized personnel across the organization.

Inquiries module 154 may enable users to manage administrative inquiries and reporting originating from service providers 120. Inquiries module 154 may include, for example, features and services such as an inquiries dashboard, a shared inquiries feature, event-driven email notifications, an organization inquiries feature, a reopen feature, and an on behalf of service.

The inquiries dashboard may be provided for service providers 120 to submit and track inquiries and for the organization support team members to respond to the inquiries. Each inquiry type and subtype may be mapped to an organization support team defined to whom the inquiry should be routed to. When an inquiry is submitted by a user for one of the service providers 120, based on the routing rules defined in the system, the appropriate support team is assigned to an inquiry. The support team members are assigned appropriate roles through which they are authorized to view the inquiries assigned to them or their team via a centralized access management suite of tools that facilitate the request, approval and fulfillment (automated and manual) of the access request.

A shared inquiry feature may be used for other organization employees. The organization employee who receives the shared inquiry is notified through email when an inquiry has been shared. Shared users can access the system to view the shared inquiry. Shared users can also add notes to the inquiry to provide advice/feedback on the inquiry. The communication between the support team and the shared user is available only to the organization and not displayed to external legal service provider users.

Event driven notification may be used to email service providers 120 users on any updates to their inquiry. Service provider users may be notified of all actions on their inquiry including comments added by support teams, attachments added or if the inquiry is completed or rejected. This feature enables service provider users to closely track the inquiries and follow up with support team on further queries. Every action on the inquiry is tracked using effective activity logs to facilitate support users to resolve the inquiry.

Employees may also create an organization inquiry. The organization inquiry creation process is similar to the external inquiries created by service providers 120 but may include some additional features to look up employees within one of the service providers 120 and search for service providers 120 used by the organization.

A reopen feature may enable organization users and service provider users to reopen completed, rejected or cancelled inquiries if they are not satisfied with the resolution. When the user reopens a closed inquiry, the system treats the closed inquiry as a parent inquiry and creates a child inquiry. The attached documents and comments may be cloned from the parent inquiry to the newly created child inquiry. The users can edit information in the new child inquiry and include additional documents or comments to support the inquiry. The cloning of parent inquiry details enables the support team users assisting with the inquiry to understand the history of original inquiry without requiring service provider users to re-enter the information from the parent inquiry. This feature also helps track “First Call Resolution”, a key measure of quality of inquiry responses by the organization support teams.

The on behalf of feature enables organization support teams to create an external inquiry on behalf of one of service providers 120. This may facilitate service provider 120 adoption rather than perpetuating email communications.

Conflicts waiver module 156 may be used for service providers 120 to request conflict waivers is essential for managing conflicts of interest that may arise when working with legal service providers, such as law firms or other legal service providers. Conflicts waiver module 156 may include a waiver request module that provides a standardized process for requesting conflict waivers from legal service providers. This will include a form that allows the law firm to provide details about the conflict and request a waiver.

Conflicts waiver module 156 may also include a communications module that enable communication with the legal service provider regarding the conflict waiver request. This may include automated notifications to the legal service provider regarding the request and updates on the status of the request.

Conflicts waiver module 156 may also include an approval process for conflict waivers. This will involve designated individuals within the organization reviewing the request and approving or denying the waiver.

Conflicts waiver module 156 may also include a waiver tracking module that may track conflict waiver requests and approvals, including the legal service provider name, the nature of the conflict, and the status of the waiver request. The module will also provide reporting capabilities to enable the organization to track the status of all conflict waiver requests.

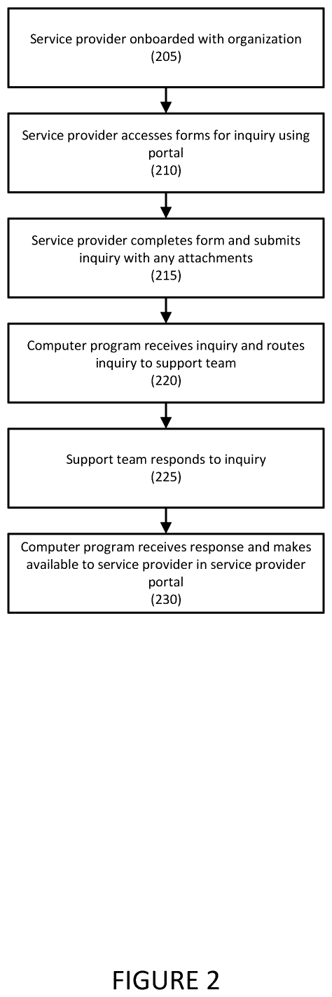

Referring to FIG. 2, a method for interfacing with service providers is disclosed according to an embodiment.

In step 205, a service provider for an organization, such as a law firm, may be onboarded to organization. As part of the onboarding, one or more individuals at the service provider may be provided with access to a portal for a service provider interface computer program. The ability for multiple people at the organization to see the inquiries results in stronger contingency options.

In step 210, using the portal, the service provider may access forms to submit an inquiry or other information to the organization. The service provider may select forms based on topic and sub-topic. The forms may be automatically populated with service provider information based on the individual accessing the portal, increasing the ease of use.

In step 215, the service provider may complete the form and may submit the inquiry with one or many attachments. For example, the service provider may upload any attachments as is necessary and/or desired.

Documentation may be linked to the inquiry, which may not happen with email, resulting in delays to resolution.

In step 220, the computer program may receive the inquiry and may route the inquiry to an appropriate support team. For example, the computer program may retrieve rules from a rules database that may specify the routing. The routing rules may route the inquiry based in the form topic or subtopic, the service provider, etc. The routing rules may be dynamic, may be configurable, and may be easy to change.

In step 225, the support team may receive the inquiry and may respond to the inquiry. It may then submit the response to the computer program. This may provide tracking for the inquiry and response.

In one embodiment, a bot may be used to provide automatic responses to the inquiry when possible. The bot may be trained with historical inquiry and resolution data.

In step 230, the computer program may receive the response and may make the response available to the service provider in the service provider portal. The response may be tracked using, for example, resolution codes.

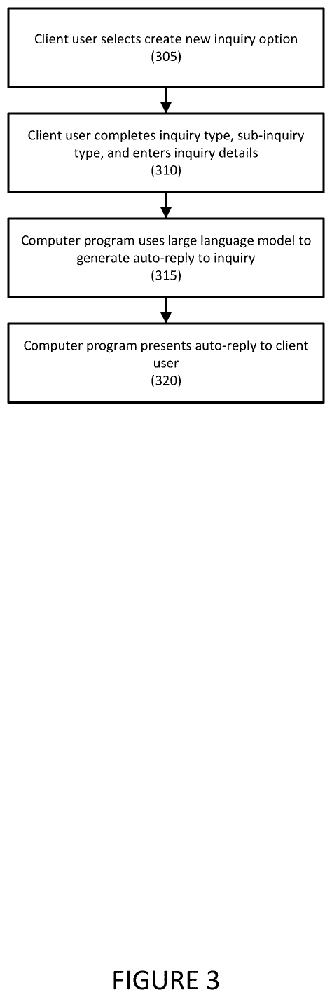

FIG. 3 depicts a method for automated inquiry resolution according to an embodiment.

In step 305, a client user may create a new inquiry option. The client user may select the option in a user interface or may request the creation of a new inquiry using a chatbot or similar.

In step 310, the client may compete a form for the inquiry. In one embodiment, using a user interface, the client may select an inquiry type, a sub-inquiry type, and may provide inquiry details. The inquiry details may be provided in text form, may be spoken, may be provided in a document, etc.

In step 315, the computer program may use a trained LLM to generate an autoreply to the inquiry, and in step 320, the computer program may present the autoreply to the client user.

For example, the computer program may generate prompts for the LLM based on the inquiry to ensure a comprehensive response. The prompts help guide the LLM in generating an accurate autoreply.

The accuracy of the response from the LLM may be determined by evaluating the relevance and coherence of the generated text, comparing it to the input inquiry, and assessing its overall quality.

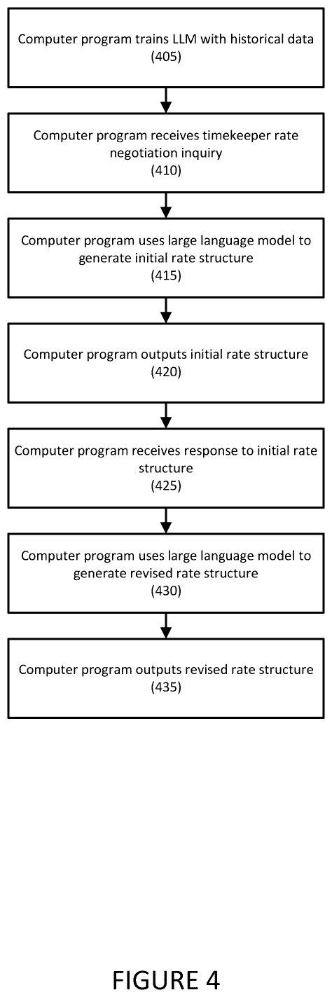

Referring to FIG. 4, a method for automated rate negotiation is provided according to an embodiment.

In step 405, a computer program may train a large language mode with legal and financial data. For example, the data may include the financial institution's requirements, historical billing data, desired rate structures, budgets, market rates, historical performance of the legal service providers, etc.

In step 410, the computer program may receive an inquiry for a timekeeper rate structure.

In step 415, the computer program may provide the inquiry to the trained LLM, and the trained LLM may return an initial rate structure. The LLM may also return negotiation strategies and potential counteroffers to the initial rate structure.

In step 420, the computer program may output the initial rate structure, the strategy, and the counteroffers to the user.

In step 425, the computer program may receive a response or counteroffer to the initial rate structure and may present the response to the LLM. In step 430, the LLM may then generate a revised rate structure, an in step 435, may output the revised rate structure to the user.

In one embodiment, in addition to receiving a response or counteroffer to the initial rate structure, the computer program may perform further analysis on the received information. This analysis may involve evaluating the feasibility and impact of the response, considering any constraints or requirements, and assessing the potential for further negotiation. The revised rate structure generated by the LLM may take these factors into account and may then be presented to the user.

Once a timekeeper rate structure is agreed to, the LLM may be trained with the information for the negotiation, including any counteroffers and the agreed upon timekeeper rate structure.

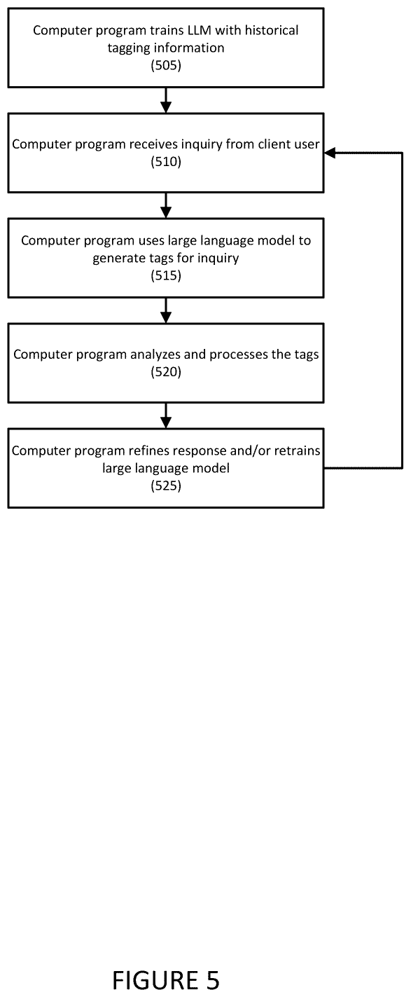

Referring to FIG. 5, a method for managing resolution tags is provided according to an embodiment.

In step 505, a computer program may train a LLM with historical inquiry tagging information. This may include tags, summaries, comments, notes, etc.

In step 510, the computer program may receive an inquiry from a client user.

In step 515, the computer program may provide the inquiry to the trained LLM, which may identify tags for the inquiry.

In step 520, after the tags are identified, the computer program may analyze and process the tags. This analysis may include, for example, categorizing the inquiry, extracting relevant information, and identifying any specific requirements or constraints associated with the inquiry.

In step 525, the computer program may refine the response from the LLM using the analysis of the tags, and may also re-train the LLM based on the analysis.

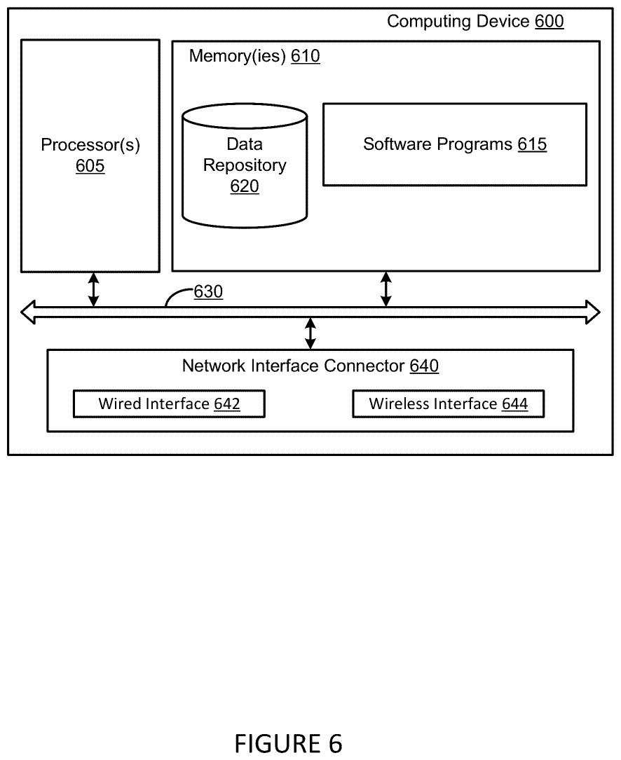

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity;

i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
onboarding, by a service provider interface computer program executed by an electronic device, a service provider with an organization computer program for an organization;
accessing, by the service provider interface computer program, one form of a plurality of forms, wherein the one form is automatically populated with service provider information for the service provider;
submitting, by the service provider interface computer program, a completed form to the organization computer program, the completed form comprising an inquiry;
routing, by the organization computer program, the completed form to an appropriate support team;
receiving, by the organization computer program and from the appropriate support team, a response to the completed form;
routing, by the organization computer program, the response to the completed form to the service provider interface computer program; and
tracking, by the organization computer program, the response to the completed form using a resolution code.

2. The method of claim 1, further comprising:
linking, by the organization computer program, the completed form to an inquiry.

3. The method of claim 1, wherein the completed form is routed to the appropriate support team using routing rules.

4. The method of claim 3, wherein the routing rules are dynamic.

5. The method of claim 1, wherein the appropriate support team comprises a bot, and the bot generates the response to the completed form.

6. The method of claim 5, wherein the bot is trained with historical inquiry and resolution data.

7. A method, comprising:
receiving, by an organization computer program for an organization executed by an organization computer processor and from a service provider interface computer program, a new inquiry option for an inquiry;
receiving, by the organization computer program, a selection of an inquiry type and a sub-inquiry type from the new inquiry option;
receiving, by the organization computer program, inquiry details for the inquiry;
providing, by the organization computer program, the inquiry type, the sub-inquiry type, and the inquiry details to a large language model;
receiving, by the organization computer program and from the large language model, an automated reply to the inquiry details; and
providing, by the organization computer program, the automated reply to the service provider interface computer program.

8. The method of claim 7, wherein the inquiry details are provided in text form, in a verbal form, or in a document.

9. The method of claim 7, wherein the organization computer program further provides a prompt for the automated reply to the large language model.

10. The method of claim 7, wherein the large language model is trained with historical data for the organization.

11. The method of claim 7, wherein the details are received via a chatbot.

12. The method of claim 7, wherein the organization computer program generates a prompt for the automated reply for the large language model based on the inquiry type and sub-inquiry type.

13. The method of claim 7, further comprising:
evaluating, by the organization computer program, an accuracy of the automated reply.

14. A method, comprising:
training, by an organization computer program for an organization executed by an organization computer processor, a large language model with legal and financial data for the organization;
receiving, by the organization computer program, an inquiry for a timekeeper rate structure from a service provider interface computer program for a service provider;
providing, by the organization computer program, the inquiry to the large language model;
receiving, by the organization computer program and from the large language model, an initial timekeeper rate structure;
providing, by the organization computer program, the initial timekeeper rate structure to the service provider interface computer program;
receiving, by the organization computer program and from the service provider interface computer program, a response to the initial timekeeper rate structure;
providing, by the organization computer program, the response to the initial timekeeper rate structure to the large language model;
receiving, by the organization computer program and from the large language model, a revised timekeeper rate structure; and
providing, by the organization computer program, the revised timekeeper rate structure to the service provider interface computer program.

15. The method of claim 14, wherein the legal and financial data comprises organization requirements, historical billing data, desired rate structures, budgets, market rates, and/or historical performance of the service provider.

16. The method of claim 14, wherein the large language model further provides negotiation strategies and potential counteroffers with the initial timekeeper rate structure.

17. The method of claim 14, wherein the inquiry comprises a prompt for the initial timekeeper rate structure for the service provider.

18. The method of claim 14, further comprising:
re-training the large language model with an agreed-up timekeeper rate structure.
